(19) United States
(12) Patent Application Publication
(10) Pub. No.: US 2026/0111507 A1
(43) Pub. Date: Apr. 23, 2026

(54) METHOD AND ELECTRONIC DEVICE FOR ENHANCING USER'S BROWSING EXPERIENCE ON A DEVICE HAVING A PLURALITY OF BROWSERS

(71) Applicant: SAMSUNG ELECTRONICS CO., LTD., Suwon-si (KR)

(72) Inventor: Mili Adlakha, Faridabad (IN)

(73) Assignee: SAMSUNG ELECTRONICS CO., LTD., Suwon-si (KR)

(21) Appl. No.: 19/096,453

(22) Filed: Mar. 31, 2025

Related U.S. Application Data
(63) Continuation of application No. PCT/KR2025/002944, filed on Mar. 5, 2025.

(30) Foreign Application Priority Data
Oct. 23, 2024 (IN) 202411080490

(51) Int. Cl. G06F 16/957; G06F 11/34

(52) U.S. Cl. CPC G06F 16/9577; G06F 11/3409

(57) ABSTRACT

A method, electronic device, and computer-readable medium are provided. the method may include includes based on receiving a request for a webpage, loading the webpage in a user selected browser among a plurality of browsers available on a device; acquiring data associated with at least one of information of the webpage, information of the device, or information of the plurality of browsers available on the device; determining whether to switch from the user selected browser to an alternative browser suitable for loading the webpage based on the at least one of the information of the webpage, the information of the device, or the information of the plurality of browsers available on the device; based on the determination to switch, identifying a recommended browser among the plurality of browsers suitable for loading the webpage; and generating an indication to utilize the recommended browser to load the webpage.

### CROSS-REFERENCES TO RELATED APPLICATIONS

This application is a continuation of International Application No. PCT/KR2025/002944, filed on March 5, 2025, at the Korean Intellectual Property office, which claims priority from Indian Patent Application No. 202411080490, filed on October 23, 2024, at the Indian Intellectual Property Office, the disclosures of which are incorporated herein by reference in their entireties.

### FIELD

The present disclosure relates to the field of webpage browsing. Particularly, the present disclosure relates to an electronic device and method for enhancing user’s browsing experience on a device having a plurality of browsers.

### BACKGROUND

A browsing experience refers to the overall experience a user has while navigating the internet using a web browser, such as Firefox®, and includes the use of tools and add-ons to enhance the user’s interaction with websites. Generally, different types of browsers usually include different variants of the components such as networking, User Interface (UI) backend, rendering engine and the like, and the browser may operate according to one or more different standards. Therefore, a webpage appears in the same manner each time that the page is loaded by a single browser, however, the same page may appear differently to a user who views the page on different browsers.

One of the related technologies disclose the webpage may be retrieved based on the browser information and rendering information associated with the webpage. However, the retrieved data disclosed in the prior art is further used to analyze and certify the browser information, based on the rendering information. However, based on the mechanism disclosed in the prior art which focuses on rectifying the issue of webpages appearing differently in multiple browsers which may also lead to user frustration, overburdening of the webpage or website which leads to inconsistent font sizes or abrupt image ratios or performance issues. If users browse continuously, users struggle due to high memory with high battery may be consumed, the user may also experience sluggish performance and overheating of the device, poor page load time and responsiveness, and a user device crashes or freezes rapidly.

The information disclosed in this background of the disclosure section is only for enhancement of understanding of the general background of the invention and should not be taken as an acknowledgement or any form of suggestion that this information forms the prior art already known to a person skilled in the art.

### SUMMARY

One or more shortcomings discussed above are overcome, and additional advantages and features are provided by the present disclosure. Other embodiments and aspects of the disclosure are described in detail herein and are considered a part of the disclosure.

In an embodiment of the present disclosure, a method being executed by one or more processors is disclosed. The method includes based on receiving a request for a webpage, loading the webpage in a user selected browser among a plurality of browsers available on a device. The method includes acquiring data associated with at least one of information of the webpage, information of the device, or information of the plurality of browsers available on the device. The method includes determining whether to switch from the user selected browser to an alternative browser suitable for loading the webpage based on the at least one of the information of the webpage, the information of the device, or the information of the plurality of browsers available on the device. The method includes based on the determination to switch, identifying a recommended browser among the plurality of browsers suitable for loading the webpage. The method generating an indication to utilize the recommended browser to load the webpage.

In an embodiment of the present disclosure, an electronic device is provided. The electronic device may include memory storing instructions. The electronic device may include at least one processor including processing circuitry, memory storing instructions that, when executed by the at least one processor individually or collectively. The at least one processor including processing circuitry, memory storing instructions that, when executed by the at least one processor individually or collectively, causes the electronic device to, based on receiving a request for a webpage, load a webpage in a user selected browser among a plurality of browsers available on the device. The at least one processor including processing circuitry, memory storing instructions that, when executed by the at least one processor individually or collectively, causes the electronic device to acquire data associated with at least one of information of the webpage, information of the device, or information of the plurality of browsers. The at least one processor including processing circuitry, memory storing instructions that, when executed by the at least one processor individually or collectively, causes the electronic device to determine to switch from the user selected browser to an alternative browser suitable for loading the webpage based on the at least one of the information of the webpage, the information of the device, or the information of the plurality of browsers available on the device. The at least one processor including processing circuitry, memory storing instructions that, when executed by the at least one processor individually or collectively, causes the electronic device to, based on the determination to switch, identify a recommended browser among the plurality of browsers suitable for loading the webpage. The at least one processor including processing circuitry, memory storing instructions that, when executed by the at least one processor individually or collectively, causes the electronic device to generate an indication to utilize the recommended browser to load the webpage.

In an embodiment of the present disclosure, a non-transitory computer-readable medium that stores one or more instructions is provided. In an embodiment, the one or more instructions that when executed by one or more processors, causes the one or more processors to, based on receiving a request for a webpage, load a webpage in a user selected browser among a plurality of browsers available on the device. In an embodiment, the one or more instructions that when executed by one or more processors, causes the one or more processors to acquire data associated with at least one of information of the webpage, information of the device, or information of the plurality of browsers. In an embodiment, the one or more instructions that when executed by one or more processors, causes the one or more processors to determine to switch from the user selected browser to an alternative browser suitable for loading the webpage based on the at least one of the information of the webpage, the information of the device, or the information of the plurality of browsers available on the device. In an embodiment, the one or more instructions that when executed by one or more processors, causes the one or more processors to, based on the determination to switch, identify a recommended browser among the plurality of browsers suitable for loading the webpage. In an embodiment, the one or more instructions that when executed by one or more processors, causes the one or more processors to generate an indication to utilize the recommended browser to load the webpage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

An embodiment of the disclosure itself, as well as a preferred mode of use, further objectives and advantages thereof, will best be understood by reference to the following detailed description of an illustrative embodiment when read in conjunction with the accompanying drawings. An embodiment is now described, by way of example only, with reference to the accompanying drawings in which:

FIG. 1. illustrates an overview of working of a browser, in accordance with an embodiment of the present disclosure;

FIG. 2. illustrates an environment depicting enhancing user’s browsing experience on a device having a plurality of browsers, in accordance with an embodiment of the present disclosure;

FIG. 3. illustrates the flowchart indicating the overview of the present disclosure that enhances user’s browsing experience on the device having a plurality of browsers, in accordance with an embodiment of the present disclosure;

FIG. 4. shows the overall architecture of the system that enhances user’s browsing experience, in accordance with an embodiment of the present disclosure;

FIG. 5. illustrates the block diagram of the system that enhances user’s browsing experience on the device having a plurality of browsers, in accordance with an embodiment of the present disclosure;

FIG. 6. illustrates the block diagram of an extraction of webpage information module for retrieving resource information, in accordance with an embodiment of the present disclosure;

FIG. 7. illustrates high level architecture for extracting browser features, in accordance with an embodiment of the present disclosure;

FIG. 8. illustrates flowchart indicating information of the device, in accordance with an embodiment of the present disclosure;

FIG. 9. illustrates a flowchart indicating the dynamic information of the browser, in accordance with an embodiment of the present disclosure;

FIG. 10. illustrates the flowchart indicating the collection of static information of the browser, in accordance with an embodiment of the present disclosure;

FIG. 11. illustrates the block diagram of a machine learning model for determining a performance score, in accordance with an embodiment of the present disclosure;

FIG. 12A. illustrates the block diagram of a correlation unit indicating correlation of the information of the webpage and the information of the plurality of browsers, in accordance with an embodiment of the present disclosure;

FIG. 12B. illustrates the block diagram of a correlation unit representing priority score mechanism to each of the features, in accordance with an embodiment of the present disclosure;

FIG. 13. shows a flowchart describing the method for enhancing user’s browsing experience on the device having a plurality of browsers, in accordance with an embodiment of the present disclosure; and

FIGS. 14A-C show use case(s) indicating optimizing user’s browsing experience on the device, accordance with an embodiment of the present disclosure.

The figures depict embodiments of the disclosure for purposes of illustration only. One skilled in the art will readily recognize from the following description that alternative an embodiment of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the scope of the disclosure.

The terms “comprises,” “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises… a” does not, without more constraints, preclude the existence of other elements or additional elements in the system or apparatus.

In the following detailed description of an embodiment of the disclosure, reference is made to the accompanying drawings that form a part hereof, and in which are shown by way of illustration an embodiment in which the description may be practiced. That embodiment is described in sufficient detail to enable those skilled in art to practice the disclosure, and it is to be understood that other embodiments may be utilized and that changes may be made without departing from the scope of the present disclosure. The following description is, therefore, not to be taken in a limiting sense.

Generally, a web browser is an application for accessing websites. When a user requests a web page from a particular website or browser, the browser retrieves its files from a web server and then displays the page on the user’s screen. The browsers may be used on a range of devices, including desktops, laptops, tablets, and smartphones. Further, the web page is a document, commonly written in HTML (hypertext markup language) viewed in an any of the browsers. The web page can be accessed by entering a URL (uniform resource locator) address into a browser’s address bar. The web page may contain, but not limited to, text, graphics, and hyperlinks to other web pages and files. Further, the web page provides information to viewers, including pictures or videos to help illustrate important topics. However, the browser or website is a collection of web pages which may be linked together. When a user type in a web address (also known as a URL), the browser will connect to the server where the website resides and download all the web pages for that website. The webpage that the user sees when he/she visit the website is usually the home page, which is the first page that is loaded when the user visits the website.

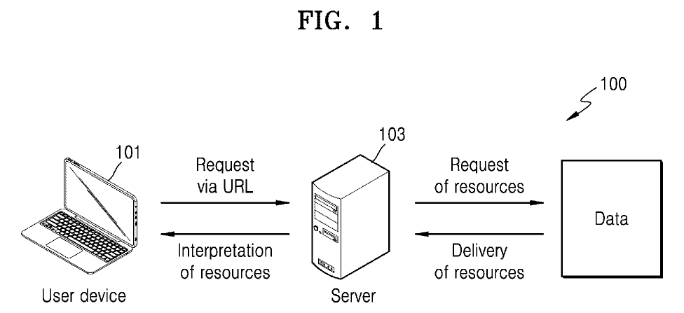

A device of the user may include multiple browsers installed in the user device. However, the plurality of browsers may have different browsing capabilities in terms of rendering engines, memory usage, extension installed, plugins installed, developer tools, javaScript, UI Backend. As each browser’s engine will interpret and render a webpage distinctively, the same website can look, feel, and function differently across multiple browsers as shown in FIG. 1. Particularly, when the user requests access to any of the webpages, the browser may further connect to the server where the website resides and download all the web pages for that website. Based on the information stored in the server, which is retrieved in the form of the webpage, the server may display it to the user device 101. For instance, consider the user wishes to check the latest cricket update. Thus, the user may enter the relevant URL via his/her user device 101. Once, the user types the URL, the request of the user to view the latest cricket update is sent to the server 103, where the website resides. The server 103 may download all the webpages related to the user request and may display it on the user device 101 as shown in FIG. 1.

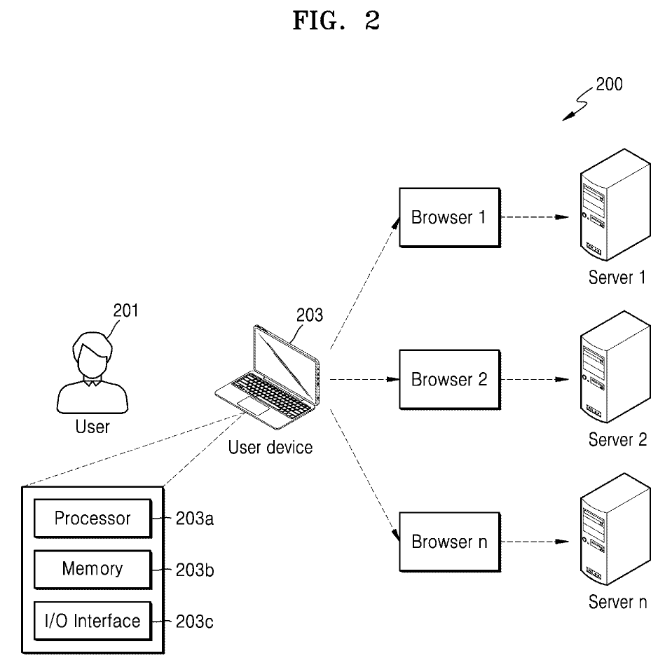

FIG. 2 illustrates a system for enhancing user’s browsing experience on a device having a plurality of browsers, in accordance with an embodiment of the present disclosure.

FIG. 2 illustrates the architecture of the system for enhancing users browsing experience. FIG. 2 includes user 201 associated with a user device 203. The user device alternatively termed as system in the present disclosure. The user device comprises a processor 203a, a memory 203b and an I/O interface 203c. A plurality of browsers (browser 1….browser n) may be installed in the user device which may be further associated with the corresponding servers (server 1…. server n) as shown in FIG. 2. For example, the user device 203 may be, but not limited to, smartphone, laptop, desktop, tablet and the like. When the user wishes to render any webpage, the user may request via his/her user device 203 to load the webpage, and the webpage may be loaded in the browser that the user had selected among the plurality of browser. For instance, the user selects browser X to load the webpage from the plurality of browsers (for example plurality of browsers may be browser “A”, browser “B”, browser “C” and the like). Once the webpage is loaded on the user selected browser, the processor 203a of the user device 203 may acquire data pertaining to information of the webpage, information of the device, and the information of the plurality of browsers including the user selected browser. For instance, consider that the user wishes to render a webpage that displays latest news articles.

To render the above-mentioned information, the user may select the browser “X” from the plurality of browsers installed in the user device associated with the user to render the news article from webpage “NEWS.COM”. In this example, the processor 203a may acquire data pertaining to information of the webpage (NEWS.COM), information of the device which information related to, but not limited to, central processing unit (CPU), graphics processing unit (GPU), network connectivity, frame rate and latency and the information of the plurality of browsers [browser “A”, browser “B”, browser “C”] including the user selected browser “X”. Based on the acquired information, the processor 203a may determine whether to switch from the user selected browser to an optimal browser suitable for loading the webpage based on the acquired data. In particular, to determine the optimal browser, the processor 203a may determine the performance score using a machine learning model indicative of performance of the user selected browser during and after loading the webpage, based on the information of the user selected browser, the information of the webpage, and the information of the device. For instance, the processor 203a may determine the performance score for the browser “X” which the user had selected to load the webpage.

In an embodiment, the processor 203a may determine the rank of the plurality of browsers installed in the user device 203 based on correlation of the information of the webpage and the information of the plurality of browsers. As an example, the processor 203a may determine the quantitative score for each of the plurality of browsers based on the correlation of the information of the webpage and the information of the plurality of browsers. That is, as an example, after determining the quantitative score of each of the plurality of browsers, the processor 203a may determine the rank the plurality of browsers and identify an optimal browser among the plurality of browsers suitable for loading the webpage based on the determined ranking of the plurality of browsers and the performance score of the user selected browser.

Once, the optimal browser among the plurality of browsers is identified, then the processor 203a may generate an indication to utilize the optimal browser to load the webpage. In an embodiment, if the user selected browser is determined as the browser having the highest rank in comparison with the plurality of the browsers, then the processor 203a may not suggest switching to an optimal browser. In an embodiment, if the user selected browser does not have the highest performance score in comparison with the plurality of the browsers, then the processor may suggest the user with the optimal browser having highest performance score. In an embodiment, if the user does not prefer to switch to the optimal browser, then the processor 203a may suggest grouping related tabs, closing irrelevant tabs based on user interaction time, and optimizations to enhance the user’s browsing experience.

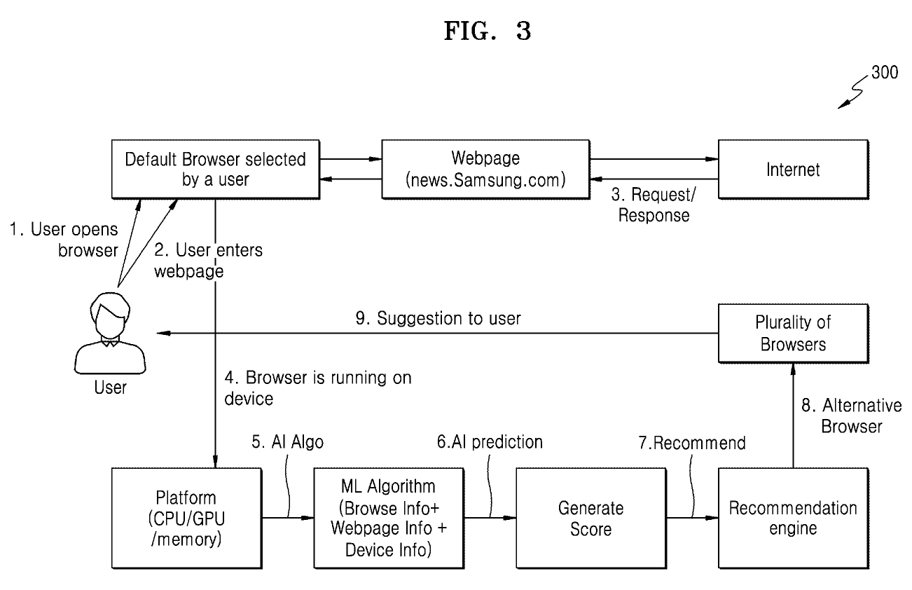

For ease of understanding, the overview of the present disclosure that enhances user’s browsing experience on the device having a plurality of browsers is illustrated below with the help of FIG. 3.

FIG. 3 illustrates a flowchart depicting a scenario in which the user may initially access the browser of his choice from the plurality of browsers installed in his device to access the webpage. For instance, at operation 1 of FIG. 3, the user opens the browser of his choice. Further, the user may enter the URL of the webpage to access the information associated with the webpage as indicated in operation 2 of FIG. 3. In other words, when the user enters the URL into a browser or clicks on a hyperlink, the browser sends a web request to the website’s server. The server then responds by sending the requested resource back to the browser, i.e., web server receives the request, at operation 3. The server runs an application to process the request. The server returns an HTTP response (output) to the browser. The client i.e., the browser receives the response. Particularly, upon request of the user to load the webpage, the electronic device may acquire the information related to the webpage, the browser in which the user has raised the request to load the webpage and the information of the device. For instance, the user may select the browser from the plurality of browsers installed in the user device associated with the user to render the news article from webpage “NEWS.COM”. The user selects the browser “A” to load the webpage in this example. In this example, the data pertaining to information of the webpage (NEWS.COM), information of the device (user device 203) which information related to, but not limited to, central processing unit (CPU), graphics processing unit (GPU), network connectivity, frame rate and latency and the information of the plurality of browsers including the user selected browser (browser “A”) is acquired. The information of the plurality of browsers comprises a plurality of features representing static information and dynamic information for each browser. The static information may be defined as the browser data that remains constant over time and the dynamic information can be defined as the browser data that changes each time it is accessed including updates, modifications, and fluctuations in browser information. Further, the information of the webpage comprises a plurality of attributes representing resource information and performance metrics, and the resource information comprises detail of all files that make up the webpage, and the performance metrics comprises data for utilization of resources by the webpage as shown in operation 4 of FIG. 3.

In other words, once the information related to the webpage, the browser and the device is acquired, the information is fed as an input to the machine learning model to determine the performance score as shown in operation 5 of FIG. 3. The performance score may be indicative of performance of the user selected browser during and after loading the webpage as shown in operation 6 of FIG. 3. Similarly, the quantitative score may be determined for each of the plurality of browsers based on the correlation of the information of the webpage and the information of the plurality of browsers. Once, the performance score and the quantitative score are determined as shown in operation 7 of FIG. 3, then the ranking unit (not shown in FIG. 3) may rank of the plurality of browsers based on correlation of the information of the webpage and the information of the plurality of browsers. Based on the determined rankings, the recommendation engine may identify the optimal browser having the highest score in comparison with the predefined threshold among the plurality of browsers suitable for loading the webpage as shown in operation 8 of FIG. 3. In an embodiment, when the user utilizes the optimal browser, the electronic device may further monitor performance of the optimal browser during browsing session after loading the webpage. In an embodiment, the electronic device may perform at least one action based on the monitored performance, i.e., grouping related tabs, closing irrelevant tabs based on user interaction time, and optimizations to enhance the user’s browsing experience as shown in operation 9 of FIG. 3. Optimizations to enhance the user’s browsing experience may include optimizations associated with the browser such as, but not limited to, clearing the browser’s cache and/or cookies, removing unused browser extensions, disabling unused browser extensions, adjusting browser settings, adjusting browser configurations, etc.

Particularly, upon request of the user to load the webpage, the user device may acquire the information related to the webpage, the browser in which the user has raised the request to load the webpage and the information of the device. For instance, the user may select the browser from the plurality of browsers installed in the user device associated with the user to render the news article from webpage “NEWS.COM”. Then, the device state identification unit 401 of the user device 203 may determine the information associated with the user device 203 such as OS information 409, CPU/GPU usage 411, memory 413 that may be utilized. Further, the feature extraction unit 403 may retrieve the information associated with the web browser and the webpage via a browser feature extraction module 415 and a webpage feature extraction module 417 respectively. For instance, the feature extraction unit 403 may retrieve the information of the plurality of browsers via the browser feature extraction module 415 which comprises the plurality of features representing static information and dynamic information for each browser. Further, the webpage feature extraction module 417 may extract the resource information and the performance matrix of the user selected webpage.

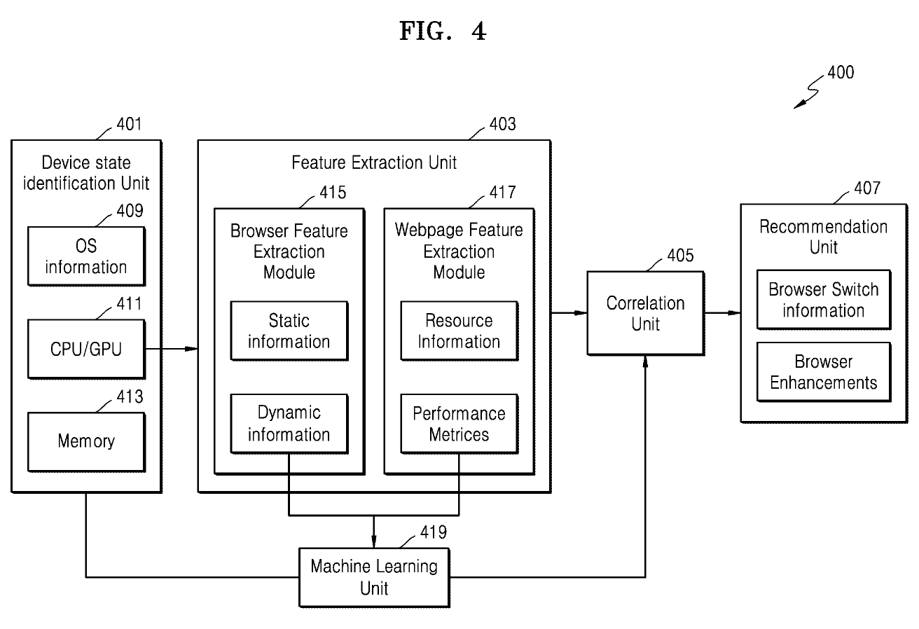

Once the above-mentioned information is retrieved, the information of the webpage, information of the device, and the information of the plurality of browsers including the user selected browser is fed as an input to a machine learning module 419 as shown in FIG. 4. For instance, the performance of the user selected browser during and after loading the webpage using the machine learning model may be determined based on the acquired information of the user selected browser, the information of the webpage, and the information of the device. For instance, consider that the user has selected the browser “X” from the plurality of browser to load the webpage. For ease of understanding, consider that the user device 203 of the user has plurality of browsers A, B, X and V. Initially, the user may select browser “X” as the default browser to load the webpage. Further, the user intent to load the webpage that render information about live cricket updates and may type a URL cricketupdates.com in the browser “X”. Thus, the webpage feature extraction module 417 may acquire the data pertaining to the webpage [cricketupdates.com], device state identification unit 401 may acquire information of the device associated with the user, the browser feature extraction module 415 may retrieve information of the plurality of browsers “A”, browser “B” and browser “V” including the user selected browser “X”.

Based on the acquired data, the machine learning unit 419 may determine the performance score which is indicative of performance of the user selected browser “X” during and after loading the webpage [cricketupdates.com]. In other words, the information of the user selected browser “X”, the information of the webpage [cricketupdates.com], and the information of the device is given as the input to the machine learning model 419, and based on these information the machine learning model 419 may determine the performance score of 2 for browser X. Similarly, the quantitative score for each of the plurality of browsers [A, B and V] may be determined based on the correlation of the information of the webpage and the information of the plurality of browsers Further, the quantitative score of the each of the plurality of browsers may be ranked. As the performance score and the quantitative score are determined, the correlation unit 405 may decide if there is a need for an alternate browser. In an example, the performance score of the user selected browser is compared with a predefined threshold to determine whether there is a need for an alternate browser to load the webpage. For instance, consider the predefined threshold may be 5. Thus, the score of user selected browser is less than the threshold. Therefore, an alternate browser among the plurality of browsers may be determined based on the determined ranking of the plurality of browsers. Once, the optimal browser among the plurality of browsers are identified, then the recommendation unit 407 may generate an indication to the user to utilize the optimal browser to load the webpage. In an embodiment, when the user utilizes the optimal browser, the electronic device may further monitor performance of the optimal browser during browsing session after loading the webpage. In an embodiment, the electronic device may perform at least one action based on the monitored performance, i.e., grouping related tabs, closing irrelevant tabs based on user interaction time, and optimizations to enhance the user’s browsing experience. Optimizations to enhance the user’s browsing experience may include optimizations associated with the browser such as, but not limited to, clearing the browser’s cache and/or cookies, removing unused browser extensions, disabling unused browser extensions, adjusting browser settings, adjusting browser configurations, etc.

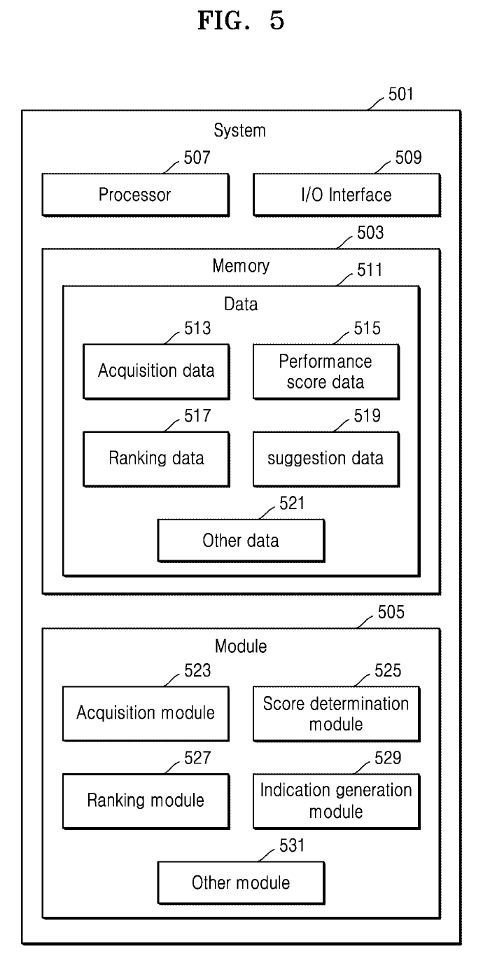

FIG. 5 illustrates a block diagram of the system to enhance user’s browsing experience on a device having a plurality of browsers, in accordance with an embodiment of the present disclosure.

In some implementations, the system 501 comprises a memory 503, a processor 507, an Input/output (I/O) Interface 509. The system may further include data 511 and modules 505. As an example, the data 511 is stored in the memory 503 configured in the system 501 as shown in the FIG. 5. In one embodiment, the data 511 may include acquisition data 513, performance score data 515, ranking data 517, suggestion data 519 and other data 521. In the illustrated FIG. 5, modules 505 are described herein in detail.

In an embodiment, the data 511 may be stored in the memory 503 in form of various data structures. Additionally, the data 511 can be organized using data models, such as relational or hierarchical data models. The other data 521 may store data, including temporary data and temporary files, generated by the modules for performing the various functions of the system 501.

In an embodiment, the data 511 stored in the memory 503 may be processed by the modules 505 of the system 501. The modules 505 may be stored within the memory 503. In an example, the modules 505 communicatively coupled to the processor 507 configured in the system 501, may also be present outside the memory 503 as shown in FIG. 5 and implemented as hardware. As used herein, the term modules refer to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the modules 505 may include, for example an acquisition module 523, a score determination module 525, a ranking module 527, an indication generation module 529 and other modules 531. The other modules 531 may be used to perform various miscellaneous functionalities of the system 501. It will be appreciated that such aforementioned modules may be represented as a single module or a combination of different modules.

In an embodiment, the acquisition module 523 may be configured to acquire acquisition data 513 pertaining to information of the webpage, information of the device, and the information of the plurality of browsers including the user selected browser. Prior to the acquiring the acquisition data 513, the user may select the browser of his choice in which he wishes to load the webpage. Specifically, the device associated with the user include plurality of browsers installed therein-. Further, the user may select a browser from the plurality of browser to load the webpage by sending the request to load the webpage. Based on the request to load the webpage, the acquisition module 523 may acquire the data pertaining to information of the webpage, information of the device, and the information of the plurality of browsers including the user selected browser.

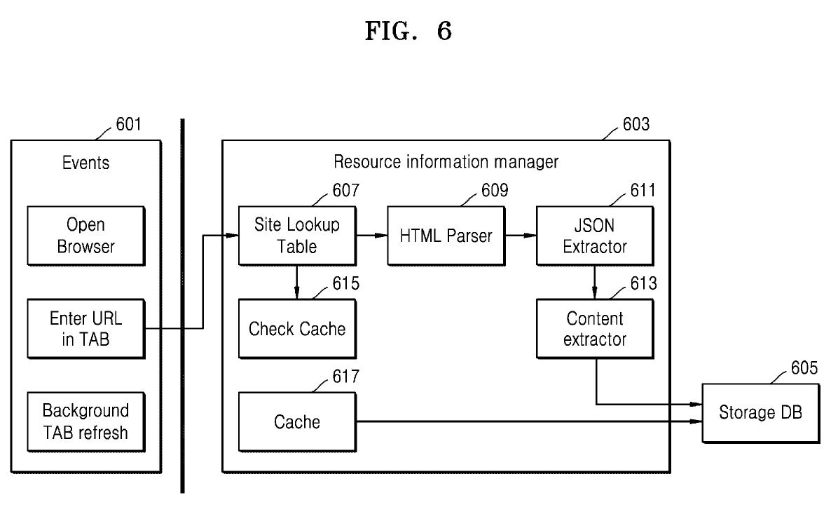

In an embodiment, the data pertaining to information of the webpage may refer to plurality of attributes representing resource information and performance metrics. The resource information comprises details of all files for instance, HTML, .XPS, .CSS, .ASP, that make up the webpage, and the performance metrics comprises data for utilization of resources by the webpage. However, the resource information may vary from one webpage to the other webpage. A Resource Information Manager (RIM) is an integral part that focuses to capture the components which make the webpage is shown in FIG. 6. The RIM 603 may include site lookup table 607, cache 617, HTML parser 609, JSON extractor 611 and content extractor 613. In an embodiment, the website resource information may be first fetched from cache 617 to avoid latency for checking cache 615 from site lookup table 607. For ease of understanding, when the initial request is made by the user to the server, the browser receives a response containing the HTML resources of the webpage that the user is trying to access. Further, the browser may parse the data i.e., analysing and converting a program into an internal format that a runtime environment can run. In other words, parsing means taking the code that is written as text (HTML, CSS) and transform it into a format that the browser can work with. The parsed data may be stored in the JSON extractor 611 and the final block of RIM 603 is the content extractor 613 that handles all the MIME information as shown in FIG. 6.

Further, the performance metrics of the webpage comprise data for utilization of resources by the webpage i.e., Performance Information Manager (PIM) captures all the performance related metrics for the webpage. For instance, the “Load Webpage” API handling, identifies the HTTP packets to check the network performance. Further, the “Performance Observer API” may inspect the contents to identify the key performance metrics which comprise the webpage loading. Furthermore, “Navigation Timestamps API” may build the waterfall layout for webpage loading.

In an embodiment, data pertaining to information of the browser may refer to plurality of features representing static information and dynamic information for each browser. The static information comprises browser data that remains constant over time. For instance, static parameter may include but not limited to name, version, user agent string, rendering engine, supported protocols, search engine, plugins/extensions, font and language, MIME type. Few of the static parameters such as name, version, user agent string, rendering engine, support protocols, search engines, plugins, font and language, and MIME type.

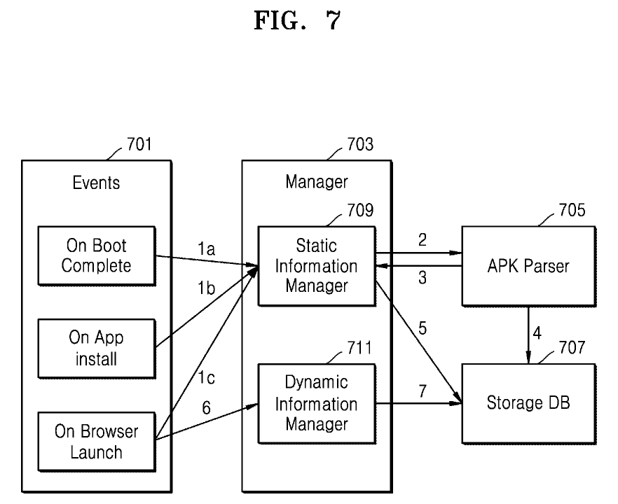

The static information may be acquired when the device booting completes, the broadcast may invoke the collection of static information. In an embodiment, the static information may be obtained when any new app is installed and the static information manager 709 may invoke the static information to check the information and when any in-app update happens, that may also trigger the service to update the static information as shown in FIG. 7. Further, the “Static Information Manager 709” may perform internal initialization and processing and there may be a subsequent call to APK parser 705 to extract the information as below:

Is it a Browser APP

If Yes, then create its instance in storage DB 707

The APK parser 705 performs its associated task and transfer the control to “Static Information Manager 709”. As explained above, the APK manager updates the storage DB 707 with browser instance subsequently the SIM processes the data (Internal logic explained in later slides), and updates the section for static information to storage DB 707.

Further, the acquisition module 523 may acquire acquisition data 513 which may be the dynamic information of the browser which comprises the browser data that changes each time it is accessed including updates, modifications, and fluctuations in the browser information. In other words, on the event of browser launch, the control signal will be sent to Dynamic Information Manager 711. The dynamic information may be retrieved when the browser is launched explicitly and stores the same information in storage DB 707. That is, the Dynamic Information Manager 711 may process and update the data to Dynamic information section of Storage DB 707. For example, the browser data that changes with respect to time which may be the number of tabs that the user has closed/opened, active tabs. In an example, the browser data may be the saved webpages, links that the user may use most frequently or frequent visited webpages or the saved webpages that refers to the webpage that the user can save locally on his device to view later without any internet connection. Further, the dynamic information of the browser data may include downloads i.e., the files that the user retrieved from the internet and the files in his local device. The files may include but not limited to document, images, videos, software, and the like. The dynamic information of the browser may include information about plugins or extensions that may be used to enhance the functionality if the web browsers which may have different capabilities and functionalities. In an embodiment, the dynamic information may refer to the changes such as switching between the normal mode and the private mode or to a user interfaced design option where the colour scheme of the browser’s interface including menus, toolbars and background us inverted to use dark colours instead of light themes.

Further, the acquisition module 523 may acquire the acquisition data 513 which may be the information of the device comprising the information related to central processing unit (CPU), graphics processing unit (GPU), network connectivity, frame rate and latency. The information pertaining to CPU/GPU usage may be acquired to understand how efficiently browser rendering quality and other performance metrics are managed. Further, the memory management information is acquired to determine the allocation, management, and optimization of memory resources to ensure different applications and processes have adequate memory to execute efficiently. The network performance is tracked to understand how effectively a network supports data transmission, considering metrics like bandwidth, latency, throughput, packet loss, jitter and error rates. Frame per second that may access the smoothness and performance of video, animation and interactive content is acquired along with the uptime and latency information which may give the difference between a user’s action and the returned response time of that action.

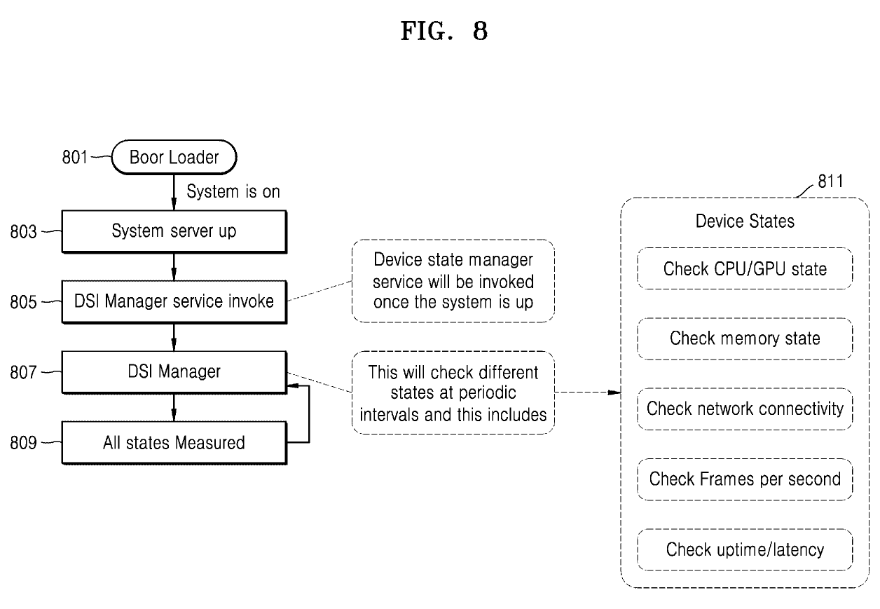

The system may acquire the information related to CPU, GPU, network connectivity, frame rate and latency and re-run at periodic intervals. In other words, when the user turns ON the system [as shown in operation 801 of FIG. 8] and the server system is up [as shown in operation 803 of FIG. 8] the device state manager service of the system may be invoked [as shown in operation 805 of FIG. 8] which may check different states at periodic intervals [as shown in operations 807 and 809 of FIG. 8] and may acquire device states 811, such as CPU/GPU, network connectivity, frame rate and latency information of the device.

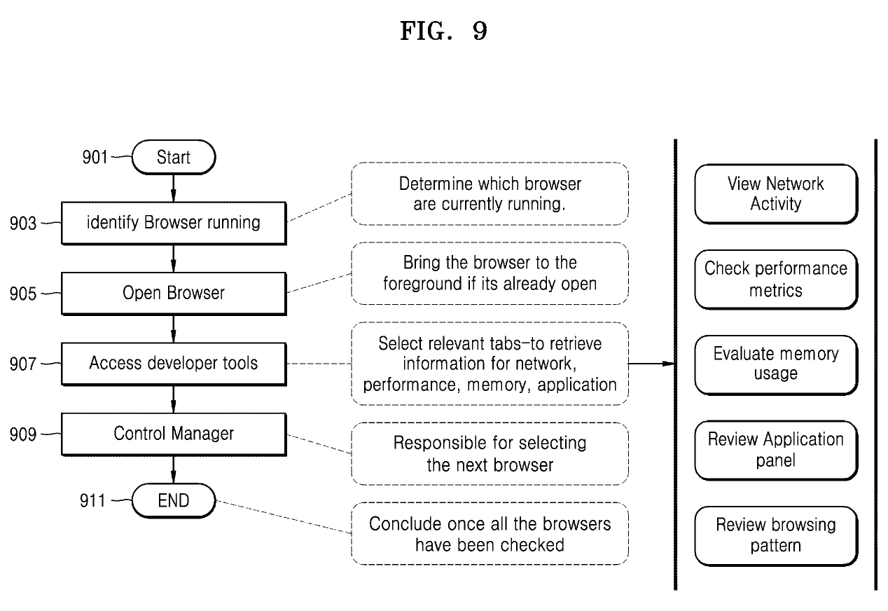

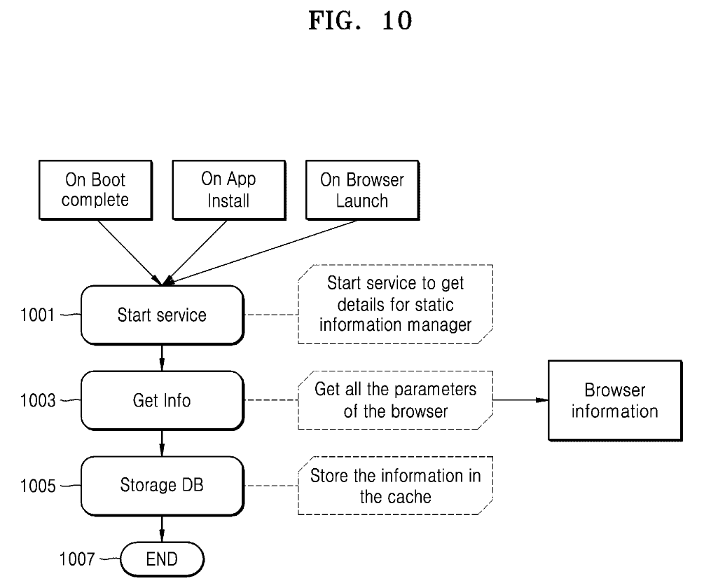

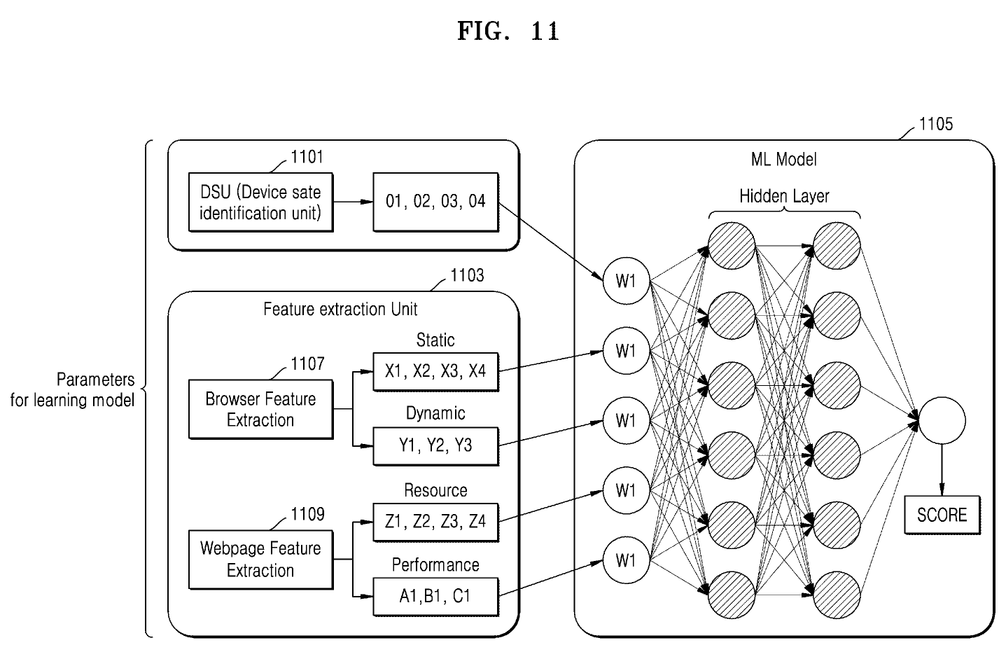

The information of the device may be acquired to understand the amount of memory utilized, performance of the device in order to monitor memory utilization with battery consumption, if there are any sluggish performance and overheating in the device. Specifically, when the device is turned on [as shown in operation 901 of FIG. 9], browser feature extraction module may check browsers that may be currently active in the user device [as shown in operation 903 of FIG. 9]. Further, the browser which the user is currently using may be identified [as shown in operation 905 of FIG. 9]. Based on the above-mentioned information of the browsers, information associated with the network, performance, memory utilized by the user device may be retrieved [as shown in operation 907 of FIG. 9]. The flow mentioned in the FIG. 9 is to understand the network activity of the user device, analyze the browsing pattern of the user and evaluate the memory utilization of the user device. This process may end once the network activity of the user device is understood, the browsing pattern of the user is analyzed, and the memory utilization of the user device is evaluated, and/or the next browser is selected by the control manager [as shown in operations 909 and 911 of FIG. 9].

In an embodiment, the data pertaining to information of the webpage, information of the device, and the information of the plurality of browsers including the user selected browser may be acquired [as shown in FIG. 10]. Specifically, when any app is installed or browser is launched in the device [as shown in operation 1001 of FIG. 10], the static information pertaining to information of the webpage, information of the device, and the information of the plurality of browsers including the user selected browser is obtained [as shown in operation 1003 of FIG. 10]. In an embodiment, the information of the plurality of browsers may be name, version, UA string, rendering engine, supported protocols, search engine, plugins/extensions, font and language and mime type of each of the plurality of browsers. After obtaining the static information, the information may be storage in the Storage DB [as shown in operation 1005 of FIG. 10]. After the information is stored, the process may end [as shown in operation 1007 of FIG. 10]. The information may be related to the plurality of parameters of the browser. Once, the above-mentioned information is acquired, a performance score data may be determined using the score determination module 525. The performance score may be indicative of performance of the user selected browser during and after loading the webpage using a machine learning model based on the acquired information of the user selected browser, the information of the webpage, and the information of the device. For instance, consider that the user has selected the browser from the plurality of browser to load the webpage as shown in FIG. 11.

For ease of understanding, consider that the device of the user has browser “A”, browser “B”, browser “C” and browser “D”. Initially, the user may select browser “A” as the default browser to load the webpage. Further, the user intent to load the webpage that render information about live cricket updates and may type a URL cricketupdates.com in the browser “A”. Thus, the acquisition module 523 may acquire the data pertaining to the webpage [cricketupdates.com], information of the device associated with the user, information of the plurality of browsers [browser “B”, browser “C” and browser “D”] including the user selected browser [browser “A”] from DSU 1101 and Feature extraction Unit 1103(including Browser Feature Extraction 1107, Webpage Feature Extraction 1109). Based on the acquired data, the performance score determination module 525 may determine the performance score using the machine learning model 1105 that is indicative of performance of the user selected browser “A” during and after loading the webpage [cricketupdates.com]. In other words, the information of the user selected browser “A”, the information of the webpage [cricketupdates.com], and the information of the device associated with the user is given as the input to the machine learning model 1105 based on which the machine learning model 1105 may determine the performance score as shown in FIG. 11. For instance, when the information of the user selected browser “A”, the information of the webpage [cricketupdates.com], and the information of the device associated with the user fed as the input to the machine learning model 1105, the machine learning model 1105 may determine the performance score for the browser “A” as 2.

In an embodiment, as data pertaining to the information of the plurality of browsers including the user selected browser is also acquired, the score determination module 525 may determine a quantitative score for each of the plurality of browsers browser “B”, browser “C” and browser “D” based on the correlation of the information of the webpage and the information of the plurality of browsers browser “B”, browser “C” and browser “D”. In other words, each of the plurality of features of the browsers are mapped with each of the plurality of the attributes. Based on mapping, the score determination module 525 may assign a priority score to each of the features. Based on the priority score assigned to each of the plurality of features of each browser, the score determination module 525 may generate the quantitative score for each browser. Thus, as per the above example, the each of the browser B, browser C and browser D may have the quantitative score that may be determined by correlating the information of the webpage and the information of the plurality of browsers. Particularly, to determine the quantitative score for each browser, the plurality of features of the browser are mapped against each of the plurality of the attributes. Once the mapping is performed, a priority score is assigned to each of the features. Further, the quantitative score is generated for each browser based on the priority score assigned to each of the plurality of features of each browser.

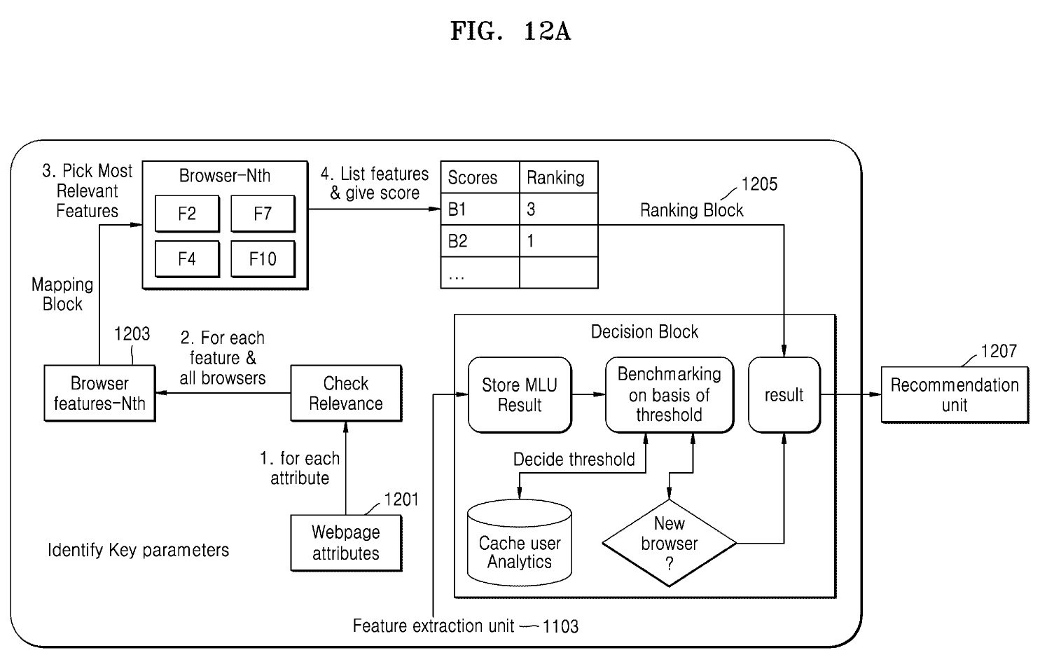

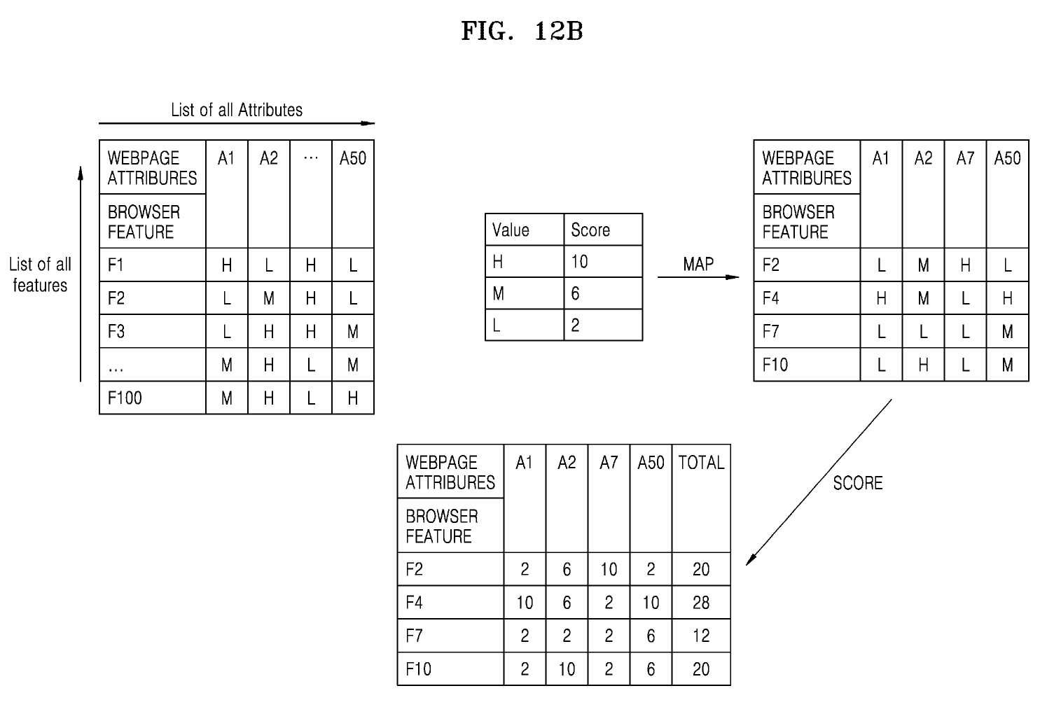

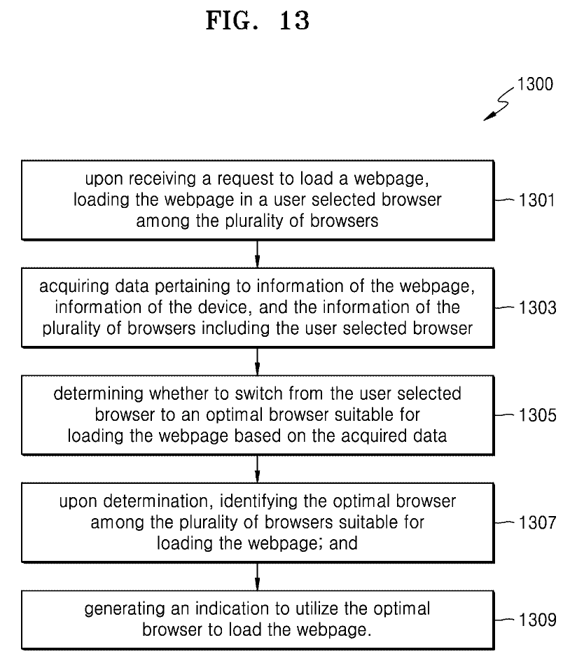

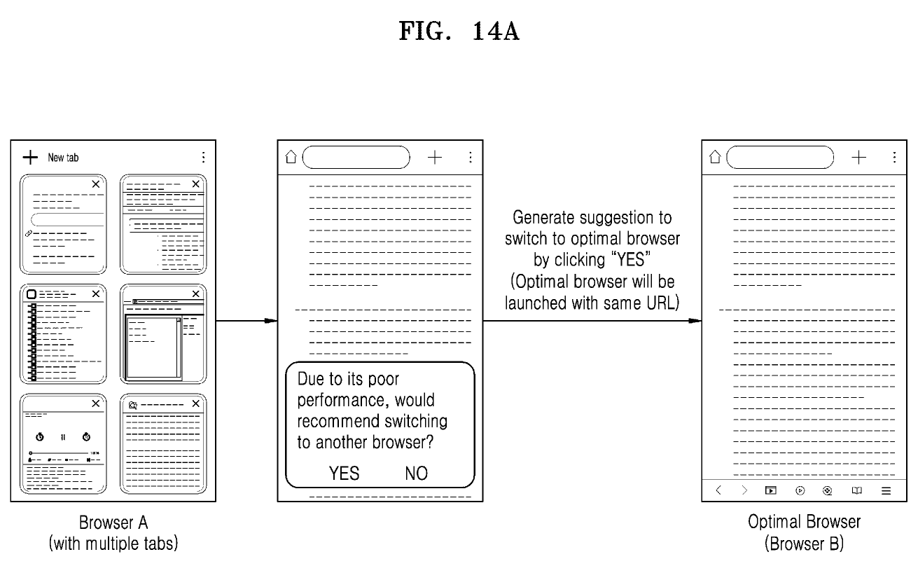

FIG. 12A illustrates a sequence diagram depicting determination of the quantitative score for each browser. Specifically, the plurality of the browsers installed in the user’s system is considered. To simplify, each browser contains the plurality of features 1203 out of the most relevant features to the webpage or the important features that may be mapped with the plurality of attributes of the webpage 1201 are considered. In other words, the most significant attributes of the webpage are identified and mapped to the browser features by checking the relevancy between the webpage and the browser. The relevancy is checked to identify the most essential Attribute-Feature which impacts the performance.

Initially, all the features of each of the browsers and the attributes of the webpages are extracted. For instance, the list of features present in the browsers is listed and are maintained in N*M format where N is the number of browsers in the device of the user and M is the total list of features. Similarly, the list of attributes present in the webpage 1201 is listed and are maintained in an array format. Once the list of features and the list of attributes are present, the score determination module 525 may identify the key browser feature and key attributes of the webpage by understanding the correlation between the browser Feature (i.e. [Browser1][Feature M Index] that are needed for a given webpage attribute which is relevance check as shown in FIG. 12A. For example, if the webpage has flash or video support as its attribute, then the score determination module may expect the browser to support different multimedia features like .wav, .mp3, .mp4, .mpg, .wmv, and .avi. Upon mapping each of the plurality of features of the browser against each of the plurality of the attributes, the score determination module may assign a priority score to each of the features as shown in FIG. 12B and generate the quantitative score for each browser based on the priority score assigned to each of the plurality of features of each browser.

In an embodiment, upon determining the performance score for the user selected browser and the quantitative score for each of the browsers, ranking block 1205 may rank the plurality of browsers based on correlation of the information of the webpage and the information of the plurality of browsers. In other words, the ranking block 1205 may rank the plurality of browsers based on the quantitative score of each of the plurality of browsers. Based on the rank of each of the plurality of browsers, decision block may further identify the optimal browser among the plurality of browsers suitable for loading the webpage based on the determined ranking of the plurality of browsers and the performance score of the user selected browser from the feature extraction unit 1103. For ease of understanding, once the performance score and the quantitative score are determined, the decision block may rank each of the browser based on the determined quantitative score. Further, the decision block may identify the optimal browser by comparing the performance score of the user selected browser with a predefined threshold to determine whether there is a need for an alternate browser to load the webpage. For example, consider that the predefined threshold may be 5 and from the above example, it was determined that the browser A was determined with the performance score of 2. In such scenarios, the decision block may identify the alternate browser among the plurality of browsers [browser “B”, browser “C”, and browser “D”] based on the determined quantitative score and the ranking of the plurality of browsers. The browser with the highest quantitative score may be ranked first and may be considered as the optimal browser. For example, the quantitative score for browser “B”, browser “C”, and browser “D” be 4, 7 and 9 respectively. Then the ranking block 1205 may rank browser “D” browser first followed by browser “C”. As the browser “D” is ranked first based on its quantitative score, the decision block may determine browser “D” as an alternative browser to load the webpage.

In an embodiment, recommendation unit 1207 may suggest the user utilize the identified optimal browser to load the webpage. The recommendation unit 1207 may suggest the user uses the optimal browser as the browser selected by the user may not be optimal in terms of memory utilization, performance of the device. Thus, when the optimal browser may be used the performance of the device may be improved and the memory utilization may be reduced, and further sluggish performance may be reduced. Once the user switches to the optimal browser, the recommendation unit 1207 may further monitor the performance of the optimal browser during browsing session after loading the webpage. Further, the recommendation unit 1207 may perform at least one action based on the monitored performance. The at least one action comprises grouping related tabs, closing irrelevant tabs based on user interaction time, and optimizations to enhance the user’s browsing experience. The recommendation unit 1207 suggest a way to enhance the user’s browsing experience i.e., the indication may be switch to the optimal browser or continue in the same browser. Based on the user’s usage pattern, browser feature enhancements will be given to the user to group tabs, pin important tabs, delete unused tabs, bookmark management etc. If the user wishes to continue in the same browser, then the indication generation module may suggest one or more actions such as grouping related tabs, closing irrelevant tabs, and optimizations to enhance the user’s browsing experience.

FIG. 13 shows a flowchart illustrating a method for enhancing user’s browsing experience on a device having a plurality of browsers, in accordance with an embodiment of the present disclosure.

As illustrated in FIG. 13, the method 1300 includes one or more blocks illustrating a method for enhancing user’s browsing experience on a device having a plurality of browsers. The method 1300 may be described in the general context of computer executable instructions. Generally, computer executable instructions can include routines, programs, objects, components, data structures, procedures, modules, and functions, which perform functions or implement abstract data types.

The order in which the method 1300 is described is not intended to be construed as a limitation, and any number of the described method blocks can be combined in any order to implement the method 1300. Additionally, individual blocks may be deleted from the methods without departing from the spirit and scope of the subject matter described herein. Furthermore, the method 1300 can be implemented with any suitable hardware, software, firmware, or combination thereof.

At block 1301, the method 1300 may load a webpage in a user selected browser among the plurality of browsers, upon receiving a request to load the webpage.

At block 1303, the method 1300 may acquire data pertaining to information of the webpage, information of the device, and the information of the plurality of browsers including the user selected browser. The information of the plurality of browsers comprises a plurality of features representing static information and dynamic information for each browser. The static information comprises browser data that remains constant over time and the dynamic information comprises the browser data that changes each time it is accessed including updates, modifications, and fluctuations in browser information. Further, the information of the webpage comprises a plurality of attributes representing resource information and performance metrics, and the resource information comprises detail of all files that make up the webpage. The performance metrics comprises data for utilization of resources by the webpage and the information of the device comprises the information related to central processing unit (CPU), graphics processing unit (GPU), network connectivity, frame rate and latency.

At block 1305, the method 1300 may determine whether to switch from the user selected browser to an optimal browser suitable for loading the webpage based on the acquired data. Particularly, using a machine learning model, a performance score may be determined which is indicative of performance of the user selected browser during and after loading the webpage, based on the information of the user selected browser, the information of the webpage, and the information of the device. Further, a quantitative score for each of the plurality of browsers may be determined based on the correlation of the information of the webpage and the information of the plurality of browsers. To determine the quantitative score of each of the browser, the electronic device may map each of the plurality of features of the browser against each of the plurality of the attributes. Upon performing the mapping, the electronic device may assign a priority score to each of the features and generate the quantitative score for each browser based on the priority score assigned to each of the plurality of features of each browser. Once, the performance score and the quantitative score is determined, ranking of the plurality of browsers may be performed based on correlation of the information of the webpage and the information of the plurality of browsers. In other words, upon determining the performance score for the user selected browser and the quantitative score for each of the browsers, the ranking module may rank the plurality of browsers based on correlation of the information of the webpage and the information of the plurality of browsers. In other words, the rank the plurality of browsers may be based on the quantitative score of each of the plurality of browsers. Based on the rank of each of the plurality of browsers, the optimal browser among the plurality of browsers suitable for loading the webpage is identified by ranking of the plurality of browsers and the performance score of the user selected browser.

At block 1307, the method 1300 may identify an optimal browser among the plurality of browsers suitable for loading the webpage based on the determined ranking of the plurality of browsers and the performance score of the user selected browser. The optimal browser is identified by comparing the performance score of the user selected browser with a predefined threshold to determine whether there is a need for an alternate browser to load the webpage. For example, consider that the predefined threshold may be 5 and it was determined that the X browser [user selected browser] was determined with the performance score of 2. In such scenarios, the alternate browser among the plurality of browsers “A”, “B”, “C” and “D” is based on the determined quantitative score and the ranking of the plurality of browsers may be suggested. The browser with the highest quantitative score may be ranked first and may be considered as the optimal browser. For example, the quantitative score for browsers A, B, C and D be 3, 4, 6 and 9 respectively. Then the ranking module may rank browser D first followed by browser “C”. As the browser “D” is ranked first based on its quantitative score, the ranking module may determine browser “D” as an alternative browser to load the webpage.

At block 1309, the method 1300 may generate an indication to utilize the optimal browser to load the webpage. Once the suggestion is sent to the user and he may switch to the optimal browser, the performance of the optimal browser may be monitored during browsing session after loading the webpage. Further, at least one action may be performed based on the monitored performance. The action comprises grouping related tabs, closing irrelevant tabs, and optimizations to enhance the user’s browsing experience.

Furthermore, one or more computer-readable storage media may be utilized in implementing embodiments consistent with the present disclosure. A computer-readable storage medium refers to any type of physical memory on which information or data readable by a processor 1602 may be stored. Thus, a computer-readable storage medium may store instructions for execution by one or more processor, including instructions for causing the processor 1602 to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

An embodiment of the present disclosure may be easily understood by way of following examples.

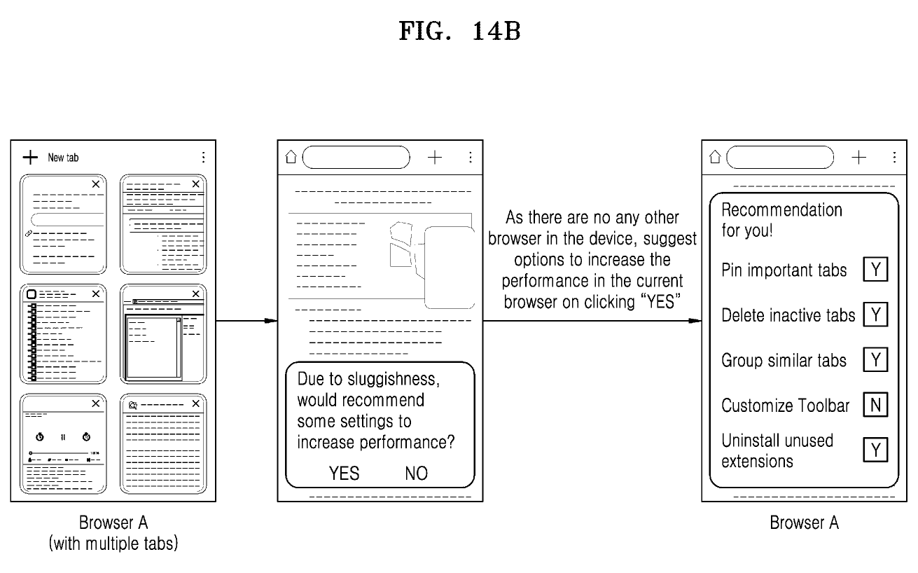

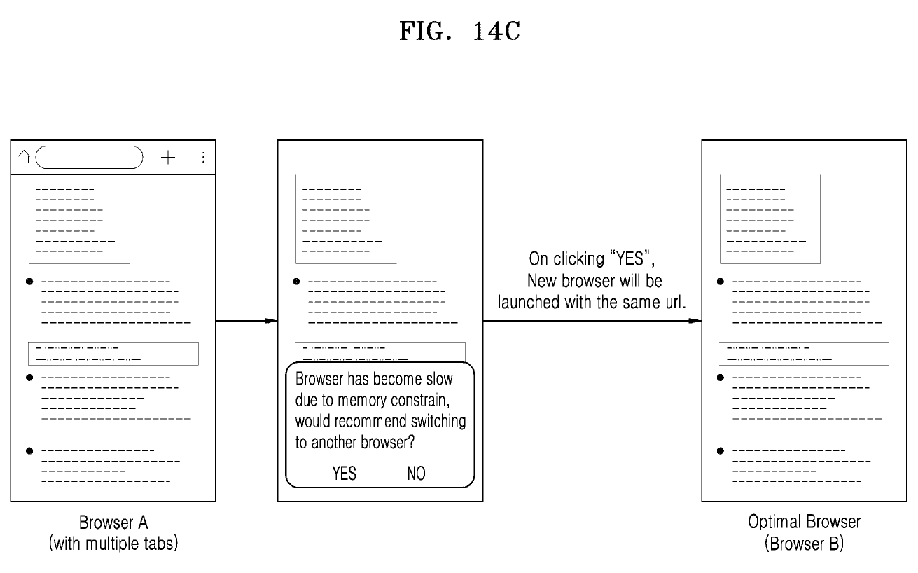

For instance, consider that the user wishes to render a webpage that displays latest news articles. However, the user may have opened multiple other tabs in his device and if users browse continuously, users struggle due to high memory with high battery may be consumed, the user may also experience sluggish performance and overheating of the device, poor page load time and responsiveness, and a user device crashes or freezes rapidly. Thus, the performance of the browser “A” may be determined, and user may be suggested that the performance of browser “A” is poor in terms of performance, memory utilization, battery usage, and the like. The suggestion may pop up on the user screen indicating that the performance of browser “A” is poor and if the user wishes to switch to another browser (optimal browser). If the user wishes to switch to another browser, then the user may click option “yes” to switch to optimal browser. Upon the user’s selection to switch to the optimal browser, the optimal browser may be launched with the same Uniform Resource Locator (URL) as shown in FIG. 14A.

In an example, the user may have opened multiple other tabs in his device and if users browse continuously, the user experience sluggish performance also the device of the user has only one browser and there are no plurality of browsers. In such instances, the processor of the electronic device not shown in FIG. 14B may provide an indication to enhance the performance of the browser i.e., the processor may indicate a prompt “due to sluggishness, would you recommend some settings to increase performance” and the user is given with the option of “YES” and “NO”. when the user clicks on option “YES”, the processor may recommend to group related tabs, close irrelevant tabs based on user interaction time, uninstall unused extension, customize tool bar, delete unwanted filed which may enhance the user’s browsing experience as shown in FIG. 14B.

In an example, the user may have opened multiple other tabs in his device and if users browse continuously in browser “A”, the user experience sluggish performance. Further, as there are multiple tabs opened and the user is switching between the tabs to debug the code, and the like, the user may experience sluggish performance and then the processor may suggest to switch to optimal browser indicating a pop-up on the user screen stating “Browser has become slow due to memory constrain, would recommend switching to another browser?” and the user is given options of “YES” and “NO”. when the user selects the option of “YES”, the optimal browser “B” may be launched with the same Uniform Resource Locator (URL) which the user had opened as shown in FIG. 14C.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

The method and electronic device may overcome the above-mentioned problems of the related technologies and improve performance of the electronic device rapidly by reducing high consumption of memory and battery usage.

In an embodiment of the present disclosure, a method being executed by one or more processors is disclosed. The method includes based on receiving a request for a webpage, loading the webpage in a user selected browser among a plurality of browsers available on a device. The method includes acquiring data associated with at least one of information of the webpage, information of the device, or information of the plurality of browsers available on the device. The method includes determining whether to switch from the user selected browser to an alternative browser suitable for loading the webpage based on the at least one of the information of the webpage, the information of the device, or the information of the plurality of browsers available on the device. The method includes based on the determination to switch, identifying a recommended browser among the plurality of browsers suitable for loading the webpage. The method generating an indication to utilize the recommended browser to load the webpage.

In an embodiment, the determining whether to switch from the user selected browser to the alternative browser comprises determining, using a machine learning model, a performance score that is indicative of performance of the user selected browser during loading of the webpage, the performance score is based on at least one of the information of the user selected browser, the information of the webpage, or the information of the device. In an embodiment, wherein the determining whether to switch from the user selected browser to the alternative browser comprises determining a ranking of the plurality of browsers based on a correlation of the information of the webpage and the information of the plurality of browsers. In an embodiment, the determining whether to switch from the user selected browser to the alternative browser comprises identifying the alternative browser based on the ranking of the plurality of browsers and the performance score of the user selected browser.

In an embodiment, the method includes monitoring performance of the recommended browser during browsing session after loading the webpage. In an embodiment, the method includes performing at least one action based on the monitored performance, wherein the at least one action comprises grouping related tabs, closing irrelevant tabs based on user interaction time, clearing the alternative browser’s cache or cookies, removing unused browser extensions, disabling unused browser extensions, adjusting browser settings, or adjusting browser configurations.

In an embodiment, the information of the plurality of browsers comprises a plurality of features representing static information and dynamic information for each browser. In an embodiment, the information of the webpage comprises a plurality of attributes representing resource information and performance metrics, and wherein the resource information comprises details of files that make up the webpage, and the performance metrics comprises information associated with utilization of resources by the webpage. In an embodiment, the information of the device comprises the information associated with at least one of central processing unit (CPU), graphics processing unit (GPU), network connectivity, frame rate, or latency.

In an embodiment, the determining the ranking of the plurality of browsers comprises determining a quantitative score for each of the plurality of browsers based on the correlation of the information of the webpage and the information of the plurality of browsers. In an embodiment, the determining the ranking of the plurality of browsers comprises ranking the plurality of browsers based on the quantitative score of each of the plurality of browsers.

In an embodiment, the identifying the alternative browser comprises determining whether the performance score of the user selected browser is greater than or equal to a predefined threshold. In an embodiment, the identifying the alternative browser comprises in case the performance score of the user selected browser is greater than or equal to the predefined threshold, identifying the alternative browser among the plurality of browsers based on the ranking of the plurality of browsers.

In an embodiment, the determining the quantitative score for the each of the plurality of browsers comprises mapping the each of a plurality of features of a respective browser against a plurality of attributes. In an embodiment, the determining the quantitative score for the each of the plurality of browsers comprises, based on the mapping, assigning a priority score to each of the plurality of features. In an embodiment, the determining the quantitative score for the each of the plurality of browsers comprises generating the quantitative score for the each of the plurality of browsers based on the priority score assigned to the each of the plurality of features.

In an embodiment of the present disclosure, an electronic device is provided. The electronic device may include memory storing instructions. The electronic device may include at least one processor including processing circuitry, memory storing instructions that, when executed by the at least one processor individually or collectively. The at least one processor including processing circuitry, memory storing instructions that, when executed by the at least one processor individually or collectively, causes the electronic device to, based on receiving a request for a webpage, load a webpage in a user selected browser among a plurality of browsers available on the device. The at least one processor including processing circuitry, memory storing instructions that, when executed by the at least one processor individually or collectively, causes the electronic device to acquire data associated with at least one of information of the webpage, information of the device, or information of the plurality of browsers. The at least one processor including processing circuitry, memory storing instructions that, when executed by the at least one processor individually or collectively, causes the electronic device to determine to switch from the user selected browser to an alternative browser suitable for loading the webpage based on the at least one of the information of the webpage, the information of the device, or the information of the plurality of browsers available on the device. The at least one processor including processing circuitry, memory storing instructions that, when executed by the at least one processor individually or collectively, causes the electronic device to, based on the determination to switch, identify a recommended browser among the plurality of browsers suitable for loading the webpage. The at least one processor including processing circuitry, memory storing instructions that, when executed by the at least one processor individually or collectively, causes the electronic device to generate an indication to utilize the recommended browser to load the webpage.

In an embodiment of the present disclosure, the determining whether to switch from the user selected browser to the alternative browser comprises determining, using a machine learning model, a performance score that is indicative of performance of the user selected browser during loading of the webpage, wherein the performance score is based on at least one of the information of the user selected browser, the information of the webpage, or the information of the device. In an embodiment of the present disclosure, the determining whether to switch from the user selected browser to the alternative browser comprises determining a ranking of the plurality of browsers based on a correlation of the information of the webpage and the information of the plurality of browsers. In an embodiment of the present disclosure, the determining whether to switch from the user selected browser to the alternative browser comprises identifying the alternative browser based on the ranking of the plurality of browsers and the performance score of the user selected browser.

In an embodiment of the present disclosure, the at least one processor including processing circuitry, memory storing instructions that, when executed by the at least one processor individually or collectively, causes the electronic device to monitor performance of the recommended browser during browsing session after loading the webpage. In an embodiment of the present disclosure, the at least one processor including processing circuitry, memory storing instructions that, when executed by the at least one processor individually or collectively, causes the electronic device to perform at least one action based on the monitored performance, wherein the at least one action comprises grouping related tabs, closing irrelevant tabs based on user interaction time, clearing the alternative browser’s cache or cookies, removing unused browser extensions, disabling unused browser extensions, adjusting browser settings, or adjusting browser configurations.

In an embodiment of the present disclosure, the information of the plurality of browsers comprises a plurality of features representing static information and dynamic information for each browser. In an embodiment of the present disclosure, the information of the webpage comprises a plurality of attributes representing resource information and performance metrics, and wherein the resource information comprises details of files that make up the webpage, and the performance metrics comprises information associated with utilization of resources by the webpage. In an embodiment of the present disclosure, the information of the device comprises the information associated with at least one of central processing unit (CPU), graphics processing unit (GPU), network connectivity, frame rate, or latency. In an embodiment of the present disclosure, the determining the ranking of the plurality of browsers comprises determining a quantitative score for each of the plurality of browsers based on the correlation of the information of the webpage and the information of the plurality of browsers. In an embodiment of the present disclosure, the determining the ranking of the plurality of browsers comprises ranking the plurality of browsers based on the quantitative score of each of the plurality of browsers.

In an embodiment of the present disclosure, the identifying the alternative browser comprises determining whether the performance score of the user selected browser is greater than or equal to a predefined threshold. In an embodiment of the present disclosure, the identifying the alternative browser comprises in case the performance score of the user selected browser is greater than or equal to the predefined threshold, identifying the alternative browser among the plurality of browsers based on the ranking of the plurality of browsers.

In an embodiment of the present disclosure, the determining the quantitative score for the each of the plurality of browsers comprises mapping the each of a plurality of features of a respective browser against a plurality of attributes. In an embodiment of the present disclosure, the determining the quantitative score for the each of the plurality of browsers comprises, based on the mapping, assigning a priority score to each of the plurality of features. In an embodiment of the present disclosure, the determining the quantitative score for the each of the plurality of browsers comprises generating the quantitative score for the each of the plurality of browsers based on the priority score assigned to each of the plurality of features.

What is claimed is:

1. A method being executed by a device, the method comprising:
based on receiving a request for a webpage, loading the webpage in a user selected browser among a plurality of browsers available on the device;
acquiring data associated with at least one of information of the webpage, information of the device, or information of the plurality of browsers available on the device;
determining whether to switch from the user selected browser to an alternative browser suitable for loading the webpage based on the at least one of the information of the webpage, the information of the device, or the information of the plurality of browsers available on the device;
based on determining to switch, identifying a recommended browser among the plurality of browsers suitable for loading the webpage; and
generating an indication to utilize the recommended browser to load the webpage.

2. The method as claimed in claim 1, wherein the determining whether to switch from the user selected browser to the alternative browser comprises:
determining, using a machine learning model, a performance score that is indicative of performance of the user selected browser during loading of the webpage, wherein the performance score is based on at least one of the information of the user selected browser, the information of the webpage, or the information of the device;
determining a ranking of the plurality of browsers based on a correlation of the information of the webpage and the information of the plurality of browsers; and
identifying the alternative browser based on the ranking of the plurality of browsers and the performance score of the user selected browser.

3. The method of claim 1, wherein the method further comprises:
monitoring performance of the recommended browser during browsing session after loading the webpage, and
performing at least one action based on the monitored performance, wherein the at least one action comprises grouping related tabs, closing irrelevant tabs based on user interaction time, clearing a cache of the alternative browser or cookies associated with the alternative browser, removing unused browser extensions, disabling unused browser extensions, adjusting browser settings, or adjusting browser configurations.

4. The method of claim 1, wherein:
the information of the plurality of browsers comprises a plurality of features representing static information and dynamic information for each browser;
the information of the webpage comprises a plurality of attributes representing resource information and performance metrics, and wherein the resource information comprises details of files that make up the webpage, and the performance metrics comprises information associated with utilization of resources by the webpage; and
the information of the device comprises the information associated with at least one of central processing unit (CPU), graphics processing unit (GPU), network connectivity, frame rate, or latency.

5. The method of claim 2, wherein the determining the ranking of the plurality of browsers comprises:
determining a quantitative score for each of the plurality of browsers based on the correlation of the information of the webpage and the information of the plurality of browsers; and
ranking the plurality of browsers based on the quantitative score of each of the plurality of browsers.

6. The method of claim 2, wherein the identifying the alternative browser comprises:
determining whether the performance score of the user selected browser is greater than or equal to a predefined threshold; and
in case the performance score of the user selected browser is greater than or equal to the predefined threshold, identifying the alternative browser among the plurality of browsers based on the ranking of the plurality of browsers.

7. The method of claim 5, wherein the determining the quantitative score for the each of the plurality of browsers comprises:
mapping the each of a plurality of features of a respective browser against a plurality of attributes;
based on the mapping, assigning a priority score to each of the plurality of features; and
generating the quantitative score for the each of the plurality of browsers based on the priority score assigned to the each of the plurality of features.

8. An electronic device comprising:
memory storing instructions; and
at least one processor including processing circuitry, wherein the instructions that, when executed by the at least one processor individually or collectively, causes the electronic device to:
based on receiving a request for a webpage, load a webpage in a user selected browser among a plurality of browsers available on the electronic device;
acquire data associated with at least one of information of the webpage, information of the electronic device, or information of the plurality of browsers;
determine to switch from the user selected browser to an alternative browser suitable for loading the webpage based on the at least one of the information of the webpage, the information of the electronic device, or the information of the plurality of browsers available on the electronic device;
based on determining to switch, identify a recommended browser among the plurality of browsers suitable for loading the webpage; and
generate an indication to utilize the recommended browser to load the webpage.

9. The electronic device of claim 8, wherein the instructions that, when executed by the at least one processor individually or collectively, causes the electronic device to:
determine, using a machine learning model, a performance score that is indicative of performance of the user selected browser during loading of the webpage, wherein the performance score is based on at least one of the information of the user selected browser, the information of the webpage, or the information of the electronic device;
determine a ranking of the plurality of browsers based on a correlation of the information of the webpage and the information of the plurality of browsers; and
identify the alternative browser based on the ranking of the plurality of browsers and the performance score of the user selected browser.

10. The electronic device of claim 8, wherein the instructions that, when executed by the at least one processor individually or collectively, causes the electronic device to:
monitor performance of the recommended browser during browsing session after loading the webpage, and
perform at least one action based on the monitored performance, wherein the at least one action comprises grouping related tabs, closing irrelevant tabs based on user interaction time, clearing a cache of the alternative browser or cookies associated with the alternative browser, removing unused browser extensions, disabling unused browser extensions, adjusting browser settings, or adjusting browser configurations.

11. The electronic device of claim 8, wherein:
the information of the plurality of browsers comprises a plurality of features representing static information and dynamic information for each browser;
the information of the webpage comprises a plurality of attributes representing resource information and performance metrics, and wherein the resource information comprises details of files that make up the webpage, and the performance metrics comprises information associated with utilization of resources by the webpage; and
the information of the electronic device comprises the information associated with at least one of central processing unit (CPU), graphics processing unit (GPU), network connectivity, frame rate, or latency.

12. The electronic device of claim 9, wherein the instructions that, when executed by the at least one processor individually or collectively, causes the electronic device to:
determine a quantitative score for each of the plurality of browsers based on the correlation of the information of the webpage and the information of the plurality of browsers; and
rank the plurality of browsers based on the quantitative score of each of the plurality of browsers.

13. The electronic device of claim 9, wherein the instructions that, when executed by the at least one processor individually or collectively, causes the electronic device to:
determine whether the performance score of the user selected browser is greater than or equal to a predefined threshold; and
in case the performance score of the user selected browser is greater than or equal to the predefined threshold, identify the alternative browser among the plurality of browsers based on the ranking of the plurality of browsers.

14. The electronic device of claim 12, wherein the instructions that, when executed by the at least one processor individually or collectively, causes the electronic device to:
map the each of a plurality of features of a respective browser against a plurality of attributes;
based on the mapping, assign a priority score to each of the plurality of features; and
generate the quantitative score for the each of the plurality of browsers based on the priority score assigned to each of the plurality of features.

15. A non-transitory computer-readable medium that stores one or more instructions, the one or more instructions that when executed by one or more processors, cause the one or more processors to:
based on receiving a request for a webpage, load a webpage in a user selected browser among a plurality of browsers available on a device;
acquire data associated with at least one of information of the webpage, information of the device, or information of the plurality of browsers;
determine to switch from the user selected browser to an alternative browser suitable for loading the webpage based on the at least one of the information of the webpage, the information of the device, or the information of the plurality of browsers available on the device;
based on determining to switch, identify a recommended browser among the plurality of browsers suitable for loading the webpage; and
generate an indication to utilize the recommended browser to load the webpage.

16. The non-transitory computer-readable medium of claim 15, wherein the one or more instructions that when executed by the one or more processors, cause the one or more processors to:
determine, using a machine learning model, a performance score that is indicative of performance of the user selected browser during loading of the webpage, wherein the performance score is based on at least one of the information of the user selected browser, the information of the webpage, or the information of the device;
determine a ranking of the plurality of browsers based on a correlation of the information of the webpage and the information of the plurality of browsers; and
identify the alternative browser based on the ranking of the plurality of browsers and the performance score of the user selected browser.

17. The non-transitory computer-readable medium of claim 15, wherein the one or more instructions that when executed by the one or more processors, cause the one or more processors to:
monitor performance of the recommended browser during browsing session after loading the webpage, and
perform at least one action based on the monitored performance, wherein the at least one action comprises: grouping related tabs, closing irrelevant tabs based on user interaction time, clearing a cache of the alternative browser or cookies associated with the alternative browser, removing unused browser extensions, disabling unused browser extensions, adjusting browser settings, or adjusting browser configurations.

18. The non-transitory computer-readable medium of claim 15, wherein:
the information of the plurality of browsers comprises a plurality of features representing static information and dynamic information for each browser;
the information of the webpage comprises a plurality of attributes representing resource information and performance metrics, and wherein the resource information comprises details of files that make up the webpage, and the performance metrics comprises information associated with utilization of resources by the webpage; and
the information of the device comprises the information associated with at least one of central processing unit (CPU), graphics processing unit (GPU), network connectivity, frame rate, or latency.

19. The non-transitory computer-readable medium of claim 16, wherein the one or more instructions that when executed by the one or more processors, cause the one or more processors to:
determine a quantitative score for each of the plurality of browsers based on the correlation of the information of the webpage and the information of the plurality of browsers; and
rank the plurality of browsers based on the quantitative score of each of the plurality of browsers.

20. The non-transitory computer-readable medium of claim 16, wherein the one or more instructions that when executed by the one or more processors, cause the one or more processors to:
determine whether the performance score of the user selected browser is greater than or equal to a predefined threshold; and
in case the performance score of the user selected browser is greater than or equal to the predefined threshold, identify the alternative browser among the plurality of browsers based on the ranking of the plurality of browsers.
